(19) United States
(12) Patent Application Publication
(10) Pub. No.: US 2026/0094942 A1
(43) Pub. Date: Apr. 2, 2026

(54) SEPARATOR, ELECTROCHEMICAL APPARATUS, AND ELECTRONIC APPARATUS

(71) Applicant: Ningde Amperex Technology Limited, Ningde (CN)

(72) Inventors: Xiaohe FAN, Ningde (CN); Zengbin WEI, Ningde (CN); Xianhui XIE, Ningde (CN)

(73) Assignee: Ningde Amperex Technology Limited, Ningde (CN)

(21) Appl. No.: 19/345,574

(22) Filed: Sep. 30, 2025

(30) Foreign Application Priority Data
Sep. 30, 2024 (CN) 202411388090.6

(51) Int. Cl. H01M 50/46; H01M 10/0525; H01M 50/42; H01M 50/434; H01M 50/443; H01M 50/446; H01M 50/451; H01M 50/491

(52) U.S. Cl. CPC H01M 50/461; H01M 10/0525; H01M 50/42; H01M 50/434; H01M 50/443; H01M 50/446; H01M 50/451; H01M 50/491

(57) ABSTRACT

A separator includes a substrate layer, an inorganic coating and a bonding layer. The inorganic coating is disposed between the substrate layer and the bonding layer and includes inorganic particles, the bonding layer includes polymer particles, and at least part of the polymer particles are embedded in pores of the inorganic coating; and in a scanning electron microscope image of a cross section of the separator at a magnification of 2000, within an area of 11.6 μm×7.6 μm, the number of polymer particles embedded in the inorganic coating at a depth greater than or equal to 100 nm is C, and the total number of polymer particles in the cross section is D, where 0.5≤C/D<0.94.

### CROSS-REFERENCE TO RELATED APPLICATION

This application claims priority to the Chinese Patent Application Ser. No. 202411388090.6, filed on Sep. 30, 2024, the content of which is incorporated herein by reference in its entirety.

### TECHNICAL FIELD

This application relates to the field of electrochemical energy storage, and in particular, to a separator, an electrochemical apparatus using the separator, and an electronic apparatus using the electrochemical apparatus.

### BACKGROUND

Electrochemical apparatuses (e.g., lithium-ion batteries), as portable chemical energy sources, are widely used in fields and industries such as consumer electronics (e.g., mobile phones, laptops, cameras, etc.), energy storage products (e.g., home energy storage, energy storage power stations, UPS power supplies, etc.), and new energy vehicles due to their advantages of high energy density, high operating voltage platform, small self-discharge, long service life, and environmental friendliness.

Separators are important parts of the electrochemical apparatuses, and bonding forces between the separators and positive and negative electrode plates affect the cycle performance and energy density of the electrochemical apparatuses. Therefore, it is necessary to develop a separator that can improve the cycle performance and energy density of an electrochemical apparatus.

### SUMMARY

This application provides a separator, an electrochemical apparatus, and an electronic apparatus.

A first aspect of this application provides a separator including a substrate layer, an inorganic coating and a bonding layer. The inorganic coating is disposed between the substrate layer and the bonding layer, and the inorganic coating includes inorganic particles. The bonding layer includes polymer particles. At least part of the polymer particles are embedded in pores of the inorganic coating. In a scanning electron microscope image of a cross section of the separator at a magnification of 2000, within an area of 11.6 μm×7.6 μm, the number of polymer particles embedded in the inorganic coating at a depth greater than or equal to 100 nm is C, and the total number of polymer particles in the cross section is D, where 0.5≤C/D<0.94.

In the separator provided in this application, part of polymers are embedded in the inorganic coating, thereby reducing thicknesses of the bonding layer and the inorganic coating on a surface of the substrate layer, reducing the thickness of the entire separator, and in turn, being conducive to improving the energy density of the electrochemical apparatus. Moreover, the applicant finds that when a number percent of polymer particles embedded in the inorganic coating is within an appropriate range, it allows the separator to maintain good ion conductivity and also allows the electrochemical apparatus to have good kinetic performance, low-temperature performance, and cycle performance.

More preferably, satisfying 0.71≤C/D<0.94 can more effectively provide the separator to maintain good ion conductivity and further allow the electrochemical apparatus to have better kinetic performance, low-temperature performance, and cycle performance.

On the basis of the first aspect, in some embodiments, an average diameter L of the polymer particles and a particle size Dv50 of the inorganic particles satisfy: 0.4≤L/Dv50≤0.8. It is conducive to increasing the depth of the polymer particles embedded in the inorganic coating and the number of the polymer particles embedded in the inorganic coating, thereby maintaining a good contact between the polymer particles and inorganic particles, improving the ion conductivity of the separator in the electrochemical apparatus, and further being conducive to allowing the electrochemical apparatus to have good kinetic performance, low-temperature performance, and cycle performance.

On the basis of the first aspect, in some embodiments, the inorganic coating has a thickness of 0.5 μm to 5 μm. It is conducive to embedding the polymer particles, and it allows the separator to have a good energy density and also have good puncture resistance. Moreover, the separator has a good storage capacity to retain an electrolyte solution and the performance in being infiltrated by the electrolyte solution, which is conducive to improving transmission of the electrolyte solution, thereby being conducive to improving the cycle performance and low-temperature performance of the electrochemical apparatus.

On the basis of the first aspect, in some embodiments, the inorganic coating has a thickness of d1 μm, where C=7.6d1+7.4. The thickness of the inorganic coating and the number of the polymer particles embedded in the inorganic coating satisfy the above relationship, which is more conducive to increasing the number of the polymer particles embedded in the inorganic coating and can further improve the ion conductivity of the separator in the electrochemical apparatus, thereby being conducive to improving the cycle performance, low-temperature performance and kinetic performance of the electrochemical apparatus.

On the basis of the first aspect, in some embodiments, the polymer particles have an average diameter L of 0.3 μm to 5 μm. It is conducive to enabling a certain number of polymer particles to be embedded in the inorganic coating to increase a bonding force between the polymer particles and the inorganic coating and interface bonding forces between the polymer particles and positive and negative electrode plates, thereby being conducive to improving the cycle performance of the electrochemical apparatus.

On the basis of the first aspect, in some embodiments, the inorganic particles in the inorganic coating have particle sizes Dv50 of 0.4 μm to 6.5 μm and Dv90 of 0.8 μm to 8.7 μm. It is conducive to allowing the polymer particles to be embedded in the inorganic coating, and further to improving the mechanical strength of the separator and improving the heat shrinkage resistance of the separator, thereby being conducive to improving the cycle performance of the electrochemical apparatus.

On the basis of the first aspect, in some embodiments, the bonding layer has a thickness of 0.5 μm to 2 μm, which can improve infiltration of the electrolyte solution along a thickness direction of the bonding layer and a horizontal direction under the condition that the electrochemical apparatus maintains a good energy density, thereby being conducive to improving the kinetic performance of the electrochemical apparatus. The bonding layer has a coating weight per unit area of 0.5 mg/5000 mm² to 3 mg/5000 mm². It maintains good bonding forces between the bonding layer and the positive and negative electrode plates as well as between the bonding layer and the inorganic coating, and is also conducive to infiltration of the electrolyte solution to improve the transmission of the electrolyte solution, thereby improving the kinetic performance and cycle performance of the electrochemical apparatus.

On the basis of the first aspect, in some embodiments, the substrate layer has a thickness of d2, satisfying: 0.05≤d1/d2≤1. The thickness of the inorganic coating and the thickness of the separator satisfy the above relationship, which satisfies embedding of the polymer particles in the inorganic coating and is also conducive to maintaining a good energy density of the electrochemical apparatus.

In some embodiments, the inorganic particles include at least one of aluminum oxide, silicon dioxide, magnesium oxide, titanium oxide, hafnium dioxide, tin oxide, cerium dioxide, nickel oxide, zirconium oxide, zinc oxide, calcium oxide, boehmite, aluminum hydroxide, magnesium hydroxide, calcium hydroxide or barium sulfate. The above inorganic particles can improve the mechanical strength of the separator and are also conducive to improving an infiltration effect of the separator on the electrolyte solution and improving the cycle performance of the electrochemical apparatus. The inorganic coating further includes a binder. The binder includes at least one of acrylic acid, methyl methacrylate, butyl acrylate, octyl acrylate, isooctyl acrylate, butadiene or acrylonitrile. The above binder is conducive to increasing a bonding force between the inorganic particles in the inorganic coating and a bonding force between the inorganic coating and the substrate layer and to increasing an interface bonding force between the inorganic coating and the substrate layer, which is conducive to transmission of lithium ions, thereby improving the cycle performance of the electrochemical apparatus.

Based on the mass of the inorganic coating, a mass percent of the inorganic particles is 85% to 95%. The mass percent of the inorganic particles is within the above range, such that thermal safety of the electrochemical apparatus is improved on the basis that the electrochemical apparatus has good kinetics.

On the basis of the first aspect, in some embodiments, the polymer particles in the bonding layer are formed by polymerization of at least two monomers selected from: butadiene, methyl acrylate, methyl methacrylate, styrene, butyl methacrylate, isooctyl acrylate, ethylene, propylene or vinylidene fluoride. The polymer particles formed by polymerization of the above monomers have a good bonding force and infiltration capacity, which provides a certain bonding force for the bonding layer. In some embodiments, the polymer particles further include at least one of acrylic acid, acrylonitrile or butadiene. The addition of the above substances can further increase a bonding force between the bonding layer and the inorganic coating, such that the bonding layer has a good bonding force and infiltration capacity, which is conducive to improving the kinetic performance of the electrochemical apparatus.

On the basis of the first aspect, in some embodiments, the separator has a porosity of 30% to 50%. It can improve a solution retention capacity of the separator, reduce the transmission impedance of the lithium ions and improve the transport capability of the lithium ions, thereby being conducive to improving the cycle performance of the electrochemical apparatus.

On the basis of the first aspect, in some embodiments, at a magnification of 10000 of a scanning electron microscope of the separator, within an area of 11.6 m×7.6 m, a surface of each polymer particle has a plurality of protrusions, and the number of the protrusions is 5 to 50. The protrusions on a surface of the bonding layer may be formed by monomers of part of polymers being polymerized and then swelling in the electrolyte solution and protruding from the surface. The applicant finds that when it is satisfied that the number of protrusions on the surface of the bonding layer is appropriate within the above area, in a first aspect, contact sites between the polymer particles and the positive and negative electrode plates are increased, and the bonding forces between the polymer particles and the positive and negative electrode plates are increased. In a second aspect, when the separator is used in the electrochemical apparatus, the above protrusions are more conducive to being embedded in an active material layer of a positive electrode plate or a negative electrode plate, thereby further improving a bonding force between the separator and the positive electrode plate or the negative electrode plate, and in turn, being conducive to improving the cycle performance and energy density of the electrochemical apparatus. In a third aspect, the protrusions in the above polymer particles are also more conducive to improving the solution retention capacity of the electrolyte solution, thereby being conducive to improving conduction of the lithium ions and improving the cycle performance and kinetic performance of the electrochemical apparatus.

On the basis of the first aspect, in some embodiments, the separator includes two bonding layers. One of the bonding layers is located on a surface of the inorganic coating away from the substrate layer, and the other one of the bonding layers is located on a surface of the substrate layer away from the inorganic coating. The bonding layer containing the inorganic coating is close to the positive electrode plate. The inorganic coating can resist the damage to the separator caused by crystal precipitation on the positive electrode plate and improve the safety of the electrochemical apparatus. The two sides of the separator contain the bonding layers, which is conducive to increasing the bonding forces between the separator and the positive electrode plate as well as between the separator and the negative electrode plate and reducing the possibility of deformation of the electrochemical apparatus in the cycling process, and also conducive to improving the ion conductivity of the separator and improving the cycle performance of the electrochemical apparatus.

A second aspect of this application further provides an electrochemical apparatus. An electrode assembly includes a positive electrode plate, a negative electrode plate, and the separator is located between the positive electrode plate and the negative electrode plate. The electrochemical apparatus includes the above separator. The number of the polymer particles embedded in the inorganic coating satisfies a suitable condition, which can improve the energy density and cycle performance of the electrochemical apparatus.

A third aspect of this application provides an electronic apparatus. The electronic apparatus includes the electrochemical apparatus. The electrochemical apparatus has a good energy density and cycle performance, which can further prolong the service life of the electronic apparatus.

### BRIEF DESCRIPTION OF DRAWINGS

The foregoing and/or additional aspects and advantages of this application will become apparent and readily understood from the description of the embodiments in conjunction with the following accompanying drawings.

FIG. 1 is a scanning electron microscope image of a cross section of a separator provided in Embodiment 1 of this application at a magnification of 2000.

FIG. 2 is a scanning electron microscope image of part of the cross section of the separator in FIG. 1 at a magnification of 10000.

FIG. 3 is a scanning electron microscope image of a surface of the separator prepared in Embodiment 1.

### DETAILED DESCRIPTION

The technical solutions in the embodiments of this application are described clearly in detail below. Apparently, the described embodiments are some rather than all of the embodiments of this application. Unless otherwise defined, all technical and scientific terms used herein bear the same meanings as what is normally understood by a person skilled in the technical field of this application. The terms used in the specification of this application are merely for the purpose of describing specific embodiments and are not intended to limit this application.

As used herein, quantities, ratios, and other values are sometimes presented herein in a range format. Understandably, such a range format is set out for convenience and brevity, and needs to be flexibly understood to include not only the numerical values explicitly specified and defined by the range, but also all individual numerical values or sub-ranges covered in the range as if each individual numerical value and each sub-range were explicitly specified.

This application provides a separator including a substrate layer, an inorganic coating and a bonding layer. The inorganic coating is disposed between the substrate layer and the bonding layer, and the inorganic coating includes inorganic particles. The bonding layer includes polymer particles. At least part of the polymer particles are embedded in pores of the inorganic coating. In a scanning electron microscope image of a cross section of the separator at a magnification of 2000, within an area of 11.6 μm×7.6 μm, the number of polymer particles embedded in the inorganic coating at a depth greater than or equal to 100 nm is C, and the total number of polymer particles in the cross section is D, where 0.5≤C/D<0.94.

In the separator provided in this application, part of polymers are embedded in the inorganic coating, thereby reducing thicknesses of the bonding layer and the inorganic coating on a surface of the substrate layer, reducing the thickness of the entire separator, and in turn, being conducive to improving the energy density of the electrochemical apparatus. Moreover, the applicant finds that when a number percent of polymer particles embedded in the inorganic coating is within an appropriate range, it allows the separator to maintain good ion conductivity, thereby allowing the electrochemical apparatus to have good kinetic performance, low-temperature performance, and cycle performance.

In some embodiments, 0.71≤C/D<0.94. The kinetic performance, low-temperature performance and cycle performance of the electrochemical apparatus can be better improved.

In some embodiments, 0.6≤C/D≤0.8. The kinetic performance, low-temperature performance and cycle performance of the electrochemical apparatus can be further improved.

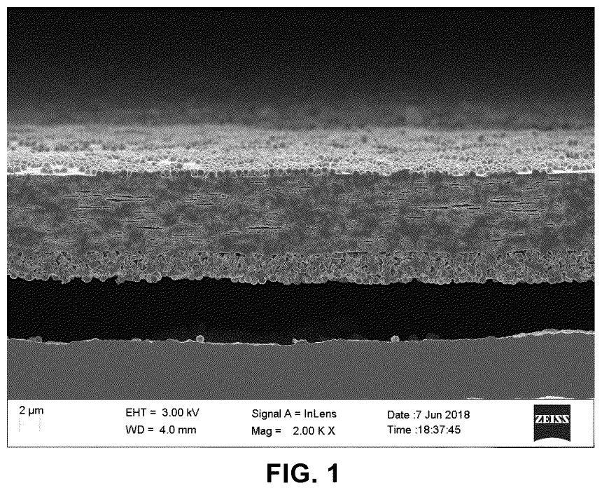

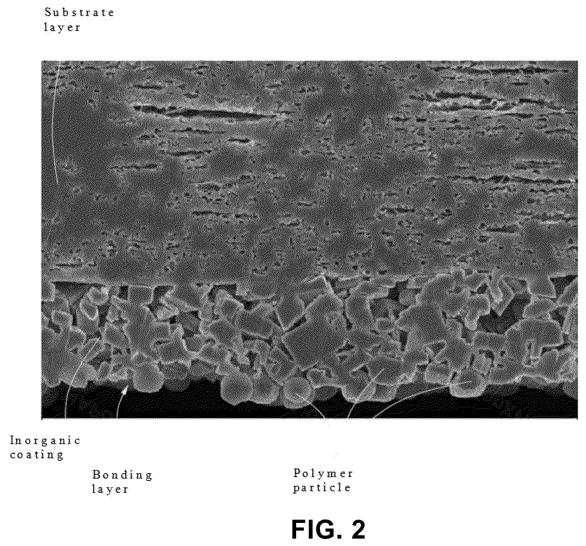

Reference is made to FIG. 1 and FIG. 2. In FIG. 2, along a thickness direction of the substrate layer, according to different colors and shapes shown in the figure, from top to bottom, a bonding layer, a substrate layer, an inorganic coating and a bonding layer may be sequentially distinguished. The bonding layers are provided on both sides of the substrate layer. As shown in FIG. 2, the inorganic coating is formed by square-type particles. Polymer particles in each bonding layer are of a spheroidal structure, and part of the polymer particles are embedded in pores of the inorganic coating.

In some embodiments, a ratio of C/D may be 0.5, 0.55, 0.6, 0.65, 0.7, 0.75, 0.8, 0.85, 0.9, 0.94, or a value falling within a range formed by any two thereof.

If the ratio of C/D is less than 0.5, there are a small number of polymer particles embedded in the inorganic coating, and most of the polymer particles are bonded to a surface of the inorganic coating, which reduces the transport capability of ions and is not conducive to improving the kinetic performance, low-temperature performance and cycle performance of the electrochemical apparatus.

In some embodiments, an average diameter L of the polymer particles and a particle size Dv50 of the inorganic particles satisfy: 0.4≤L/Dv50≤0.8. The average diameter of the polymer particles and the particle size of the inorganic particles satisfy the above condition, which is conducive to increasing the depth of the polymer particles embedded in the inorganic coating and the number of the polymer particles embedded in the inorganic coating, such that the polymer particles can be fully embedded in the pores of the inorganic coating, e.g., among the plurality of adjacent inorganic particles, thereby maintaining a good contact between the polymer particles and the inorganic particles, improving the ion conductivity of the separator in the electrochemical apparatus, and further being conducive to allowing the electrochemical apparatus to have good kinetic performance, low-temperature performance, and cycle performance.

If a ratio of L/Dv50 is relatively small, e.g., less than 0.4, the particle size Dv50 of the inorganic particles is relatively large, or the average diameter L of the polymer particles is relatively small. The polymer particles may be fully embedded in gaps between the inorganic particles, which may reduce a bonding force between the inorganic coating and a corresponding bonding layer, thereby affecting interface stability between the separator in the electrochemical apparatus and positive and negative electrode plates, and affecting the cycle performance of the electrochemical apparatus. If the ratio of L/Dv50 is relatively large, e.g., greater than 0.8, the average diameter L of the polymer particles is relatively close to the particle size Dv50 of the inorganic particles, which is not conducive to embedding the polymer particles in the pores of the inorganic coating, and not conducive to improving the ion conductivity of the separator in the electrochemical apparatus, thereby being not conducive to improving the kinetic performance, low-temperature performance and cycle performance of the electrochemical apparatus. In some embodiments, the ratio of L/Dv50 may be 0.4, 0.5, 0.6, 0.7, 0.8, or a value falling within a range formed by any two thereof.

Dv50, also referred to as “median particle size”, represents a particle size at which the inorganic particles reach 50% of a cumulative volume from a small particle size side in the volume-based particle size distribution.

In some embodiments, the inorganic coating has a thickness of 0.5 μm to 5 μm. The thickness of the inorganic coating being within the above range is conducive to embedding of the polymer particles, and allows the separator to have a good energy density and also have good puncture resistance. Moreover, the separator has a good storage capacity to retain an electrolyte solution and the performance in being infiltrated by the electrolyte solution, which is conducive to improving transmission of the electrolyte solution, thereby being conducive to improving the cycle performance and low-temperature performance of the electrochemical apparatus. Moreover, the thickness of the inorganic coating being within the above range is further conducive to reducing the self-discharge rate of the electrochemical apparatus and improving the stability of the electrochemical apparatus. In some embodiments, the thickness of the inorganic coating may be 0.5 μm, 0.8 μm, 1 μm, 1.5 μm, 1.8 μm, 2 μm, 2.5 μm, 3 μm, 3.5 μm, 4 μm, 4.5 μm, 5 μm, or a value falling within a range formed by any two thereof.

In some embodiments, the inorganic coating has a thickness of d1 μm, where C=7.6d1+7.4. The thickness of the inorganic coating and the number of the polymer particles embedded in the inorganic coating satisfy the above relationship, which is more conducive to increasing the number of the polymer particles embedded in the inorganic coating and can further improve the ion conductivity of the separator in the electrochemical apparatus, thereby being conducive to improving the cycle performance, low-temperature performance and kinetic performance of the electrochemical apparatus.

In some embodiments, the polymer particles have an average diameter L of 0.3 μm to 5 μm. The average diameter L of polymers being within the above range is conducive to embedding a certain number of polymer particles in the inorganic coating to increase a bonding force between the polymer particles and the inorganic coating and interface bonding forces between the polymer particles and positive and negative electrode plates, thereby being conducive to improving the cycle performance of the electrochemical apparatus. If the average diameter L of the polymer particles is relatively small, e.g., less than 0.3 μm, there are a relatively large number of polymer particles, which can slow down the transmission of the electrolyte solution on the surface of the bonding layer and reduce the cycle performance of the electrochemical apparatus. If the average diameter L of the polymer particles is relatively large, e.g., greater than 5 μm, the number of the polymer particles embedded in the inorganic coating may be reduced, which reduces the ion conductivity of the separator in the electrochemical apparatus, thereby reducing the cycle performance and kinetic performance of the electrochemical apparatus. In some embodiments, the polymer particles have an average diameter L of 0.3 μm, 0.5 μm, 1 μm, 1.5 μm, 2 μm, 2.5 μm, 3 μm, 3.5 μm, 4 μm, 4.5 μm, 5 μm, or a value falling within a range formed by any two thereof.

In some embodiments, the inorganic particles in the inorganic coating have particle sizes Dv50 of 0.4 μm to 7 μm and Dv90 of 0.8 μm to 9 μm. The particle sizes Dv50 and Dv90 of the inorganic particles satisfy the above ranges, which is conducive to embedding the polymer particles in the inorganic coating, and also conducive to improving the mechanical strength of the separator and improving the heat shrinkage resistance of the separator, thereby being conducive to improving the cycle performance of the electrochemical apparatus. The particle size Dv50 of the inorganic particles may be 0.4 μm, 0.5 μm, 0.6 μm, 0.7 μm, 0.8 μm, 0.9 μm, 1 μm, 1.5 μm, 2 μm, 2.5 μm, 3 μm, 3.5 μm, 4 μm, 4.5 μm, 5 μm, 5.5 μm, 6 μm, 6.5 μm, 7 μm, or a value falling within a range formed by any two thereof. The particle size Dv90 of the inorganic particles may be 0.8 μm, 1 μm, 1.2 μm, 1.5 μm, 1.8 μm, 2.3 μm, 2.7 μm, 3.2 μm, 3.7 μm, 4 μm, 4.2 μm, 4.5 μm, 4.8 μm, 5 μm, 5.5 am, 6 μm, 6.5 μm, 7 μm, 7.5 μm, 8 μm, 8.5 μm, 9 μm, or a value falling within a range formed by any two thereof. Dv90 represents a particle size at which the inorganic particles reach 90% of a cumulative volume from a small particle size side in the volume-based particle size distribution.

In some embodiments, the inorganic particles in the inorganic coating have a particle size Dv10 of 0.2 μm to 0.6 μm. In some embodiments, the particle size Dv10 of the inorganic particles may be 0.2 μm, 0.3 μm, 0.4 μm, 0.6 μm, or a value falling within a range formed by any two thereof.

In some embodiments, the bonding layer has a thickness of 0.5 μm to 2 μm. The thickness of the bonding layer being within the above appropriate range can improve infiltration of the electrolyte solution along a thickness direction of the bonding layer and a horizontal direction under the condition that the electrochemical apparatus maintains a good energy density, thereby being conducive to improving the kinetic performance of the electrochemical apparatus. In some embodiments, the thickness of the bonding layer may be 0.5 μm, 0.8 μm, 1 μm, 1.2 μm, 1.5 μm, 1.8 μm, 2 μm, or a value falling within a range formed by any two thereof.

The bonding layer has a coating weight per unit area of 0.5 mg/5000 mm² to 3 mg/5000 mm². The coating weight per unit area of the bonding layer being within the above range maintains good bonding forces between the bonding layer and the positive and negative electrode plates as well as between the bonding layer and the inorganic coating, and is also conducive to infiltration of the electrolyte solution to improve the transmission of the electrolyte solution, thereby improving the kinetic performance and cycle performance of the electrochemical apparatus. In some embodiments, the coating weight per unit area of the bonding layer is 0.5 mg/5000 mm², 1 mg/5000 mm², 1.5 mg/5000 mm², 2 mg/5000 mm², 2.5 mg/5000 mm², 3 mg/5000 mm², or a value falling within a range formed by any two thereof.

In some embodiments, the substrate layer has a thickness of d2. The separator satisfies: 0.05≤d1/d2≤1.0. The thickness of the inorganic coating and the thickness of the substrate layer satisfy the above relationship, which satisfies embedding of the polymer particles in the inorganic coating and is also conducive to maintaining a good energy density of the electrochemical apparatus. In some embodiments, a ratio of d1/d2 may be 0.05, 0.1, 0.2, 0.3, 0.5, 0.8, 0.9, 1, or a value falling within a range formed by any two thereof.

In some embodiments, the inorganic particles include at least one of aluminum oxide, aluminum oxide, silicon dioxide, magnesium oxide, titanium oxide, hafnium dioxide, tin oxide, cerium dioxide, nickel oxide, zirconium oxide, zinc oxide, calcium oxide, boehmite, aluminum hydroxide, magnesium hydroxide, calcium hydroxide or barium sulfate. The above inorganic particles can improve the mechanical strength of the separator and are also conducive to improving an infiltration effect of the separator on the electrolyte solution and improving the cycle performance of the electrochemical apparatus.

The inorganic coating further includes a binder. The binder includes at least one of acrylic acid, methyl methacrylate, butyl acrylate, octyl acrylate, isooctyl acrylate, butadiene or acrylonitrile. The above binder is conducive to increasing a bonding force between the inorganic particles in the inorganic coating and a bonding force between the inorganic coating and the substrate layer and to increasing an interface bonding force between the inorganic coating and the substrate layer, which is conducive to transmission of lithium ions, thereby improving the cycle performance of the electrochemical apparatus. Based on a mass of the inorganic coating, a mass percent of the binder is 5% to 15%. The mass percent of the binder is within the above range, such that the inorganic coating and the substrate layer have a good bonding force therebetween. In some embodiments, based on the mass of the inorganic coating, the mass percent of the binder may be 5%, 7%, 8%, 9%, 10%, 12%, 13%, 14%, 15%, or a value falling within a range formed by any two thereof.

Based on the mass of the inorganic coating, a mass percent of the inorganic particles is 85% to 95%. The mass percent of the inorganic particles is within the above range, such that thermal safety of the electrochemical apparatus is improved on the basis that the electrochemical apparatus has good kinetics. In some embodiments, based on the mass of the inorganic coating, the mass percent of the inorganic particles may be 85%, 87%, 89%, 90%, 92%, 93%, 94%, 95%, or a value falling within a range formed by any two thereof.

In some embodiments, the polymer particles in the bonding layer is formed by polymerization of at least two monomers selected from: butadiene, methyl acrylate, methyl methacrylate, styrene, butyl methacrylate, isooctyl acrylate, ethylene, propylene or vinylidene fluoride. The polymer particles formed by polymerization of the above monomers have a good bonding force and infiltration capacity, which provides a certain bonding force for the bonding layer.

In some embodiments, the polymer particles further include at least one of acrylic acid, acrylonitrile or butadiene. The addition of the above substances can further increase a bonding force between the bonding layer and the inorganic coating, such that the bonding layer has a good bonding force and infiltration capacity, which is conducive to improving the kinetic performance of the electrochemical apparatus.

In some embodiments, the separator has a porosity of 30% to 50%. The porosity of the separator being within the above range can not only improve a solution retention capacity of the separator, but also reduce the transmission impedance of the lithium ions and improve the transport capability of the lithium ions, thereby being conducive to improving the cycle performance and kinetic performance of the electrochemical apparatus. In some embodiments, the porosity of the separator may be 30%, 32%, 35%, 38%, 40%, 42%, 45%, 48%, 50%, or a value falling within a range formed by any two thereof. Preferably, the porosity of the separator is 35% to 45%.

In some embodiments, at a magnification of 10000 of a scanning electron microscope of the separator, within an area of 11.6 μm×7.6 μm, the number of the polymer particles is 10 to 60. If there are a relatively small number of polymer particles, bonding forces between the bonding layer and the positive electrode plate as well as between the bonding layer and the negative electrode plate are reduced. If there are a relatively larger number of polymer particles, the rate performance of the electrochemical apparatus may be reduced. In some embodiments, the number of the polymer particles is 10, 15, 20, 25, 30, 35, 40, 45, 50, 55, 60, or a value falling within a range formed by any two thereof.

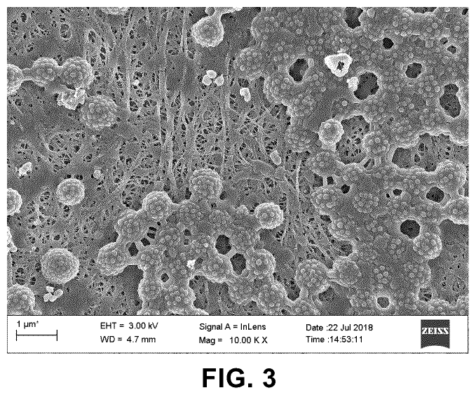

A surface of each polymer particle has a plurality of protrusions. In a scanning electron microscope image of the separator at a magnification of 10000, within an area of 11.6 μm×7.6 μm, the number of the protrusions is 5 to 50, as shown in FIG. 3. The protrusions on a surface of the bonding layer may be formed by monomers of part of polymers being polymerized and then swelling in the electrolyte solution and protruding from the surface. The applicant finds that when it is satisfied that the number of protrusions on the surface of the bonding layer is appropriate within the above area, in a first aspect, contact sites between the polymer particles and the positive and negative electrode plates are increased, and the bonding forces between the polymer particles and the positive and negative electrode plates are increased. In a second aspect, when the separator is used in the electrochemical apparatus, the above protrusions are more conducive to being embedded in an active material layer of a positive electrode plate or a negative electrode plate, and further improve a bonding force between the polymer particles and the positive electrode plate or the negative electrode plate, thereby being conducive to improving the cycle performance and energy density of the electrochemical apparatus. In a third aspect, the protrusions in the above polymer particles are also more conducive to improving the solution retention capacity of the electrolyte solution, thereby being conducive to improving conduction of the lithium ions and improving the cycle performance and kinetic performance of the electrochemical apparatus. In some embodiments, within the area of 11.6 μm×7.6 μm, the number of the protrusions may be 5, 8, 10, 12, 14, 16, 18, 20, 24, 28, 30, 32, 34, 38, 40, 44, 48, 50, or a value falling within a range formed by any two thereof.

The number of the above polymer particles is related to elements such as substances of the polymer particles (types of monomers), the coating weight per unit area, the particle size of the polymer particles, and a coating topography. By adjusting at least one of the above elements, the number of the polymer particles within the above area can be changed. The number of the protrusions on the surfaces of the above polymer particles is related to the substances of the polymer particles (types of monomers), a degree of crosslinking of the polymer particles, and a ratio of core-shell structures of the polymer particles formed by polymerization of polymer monomers. By adjusting the above elements, the number of the protrusions within the above area can be changed.

In some embodiments, the separator includes two bonding layers. One of the bonding layers is located on a surface of the inorganic coating away from the substrate layer, and the other one of the bonding layers is located on a surface of the substrate layer away from the inorganic coating. The bonding layer containing the inorganic coating is close to the positive electrode plate. The inorganic coating can resist the damage to the separator caused by crystal precipitation on the positive electrode plate and improve the safety of the electrochemical apparatus. The two sides of the separator contain the bonding layers, which is conducive to increasing the bonding forces between the separator and the positive electrode plate as well as between the separator and the negative electrode plate and reducing the possibility of deformation of the electrochemical apparatus in the cycling process, and also conducive to improving the ion conductivity of the separator and improving the cycle performance of the electrochemical apparatus.

In this application, by adjusting and controlling the particle size Dv50 of the inorganic particles, the thickness of the inorganic coating, the coating weight per unit area of the bonding layer, or the average diameter L of the polymer particles, the number of the polymer particles embedded in the inorganic coating, i.e., the ratio of C/D, is adjusted.

An embodiment of this application further provides an electrochemical apparatus, including a shell, an electrode assembly and an electrolyte solution. A battery cell and the electrolyte solution are located within the shell. The shell may be a packaging bag obtained by encapsulation using an encapsulation film, such as an aluminum-plastic film. For example, the electrochemical apparatus is a pouch secondary battery. In other embodiments, the electrochemical apparatus may also be a steel-shell battery, an aluminum-shell battery, or the like.

The electrode assembly includes a positive electrode plate, a negative electrode plate and a separator. The separator is located between the positive electrode plate and the negative electrode plate. The electrode assembly may be of a stacked structure which is formed by stacking the positive electrode plate, the separator and the negative electrode plate. In other embodiments, the electrode assembly may also be of a jelly-roll structure which is formed by stacking and then winding the positive electrode plate, the separator and the negative electrode plate.

### Positive Electrode Plate

A positive electrode plate includes a positive current collector and a positive active layer disposed on the positive current collector. The positive current collector may use aluminum foil, nickel foil, or the like, and may also be a composite current collector disclosed in the prior art, for example but not limited to a current collector formed by combining the foregoing conductive foil with a polymer substrate. The positive active layer includes a positive active material. The positive active material includes a compound that enables reversible intercalation and deintercalation of lithium ions, i.e., a lithiated intercalation compound. In some embodiments, the positive active material may include a lithium transition metal composite oxide. The lithium transition metal composite oxide contains lithium and at least one element selected from cobalt, manganese, or nickel. In some embodiments, the positive active material may include, but is not limited to, at least one of lithium cobalt oxide, lithium nickel cobalt manganese oxide, lithium nickel manganese aluminum oxide, lithium iron phosphate, lithium vanadium phosphate, lithium cobalt phosphate, lithium manganese phosphate, lithium manganese iron phosphate, lithium iron silicate, lithium vanadium silicate, lithium cobalt silicate, lithium manganese silicate, spinel lithium manganese oxide, spinel lithium nickel manganese oxide, or lithium titanium oxide.

The positive active layer further includes a binder for bonding positive active material particles so as to form a film layer, and a bonding force between the positive active layer and the positive current collector can also be increased. In some embodiments, the binder may include, but is not limited to, at least one of polyvinyl alcohol, hydroxypropyl cellulose, diacetyl cellulose, polyvinyl chloride, carboxylated polyvinyl chloride, polyvinyl fluoride, a polymer containing ethylidene oxygen, polyvinylpyrrolidone, polyurethane, polytetrafluoroethylene, poly(1,1-difluoroethylene), polyethylene, polypropylene, styrene-butadiene rubber, acrylic styrene-butadiene rubber, epoxy resin, nylon, or the like.

The positive active layer may further include a conductive material. The conductive material includes, but is not limited to, a carbon-based material, a metal-based material, a conductive polymer, or any combination thereof. In some embodiments, the carbon-based material may include, but is not limited to, natural graphite, artificial graphite, carbon black, acetylene black, Ketjen black, carbon fibers, or any combination thereof. In some embodiments, the metal-based material may include, but is not limited to, metal powders, or metal fibers, such as copper, nickel, aluminum, or silver. In some embodiments, the conductive polymer may be a polyphenylene derivative.

### Separator

The material and the shape of the separator used in the electrochemical apparatus according to this application are not particularly limited, and may be based on any technology disclosed in the prior art. In some embodiments, the separator includes a polymer or an inorganic substance or the like made of a material that is stable to the electrolyte solution of this application. In this application, the separator described above is used.

For example, the substrate layer is a non-woven fabric, film or composite film, which, in each case, is of a porous structure. The material of the substrate layer is at least one selected from polyethylene, polypropylene, polyethylene terephthalate, or polyimide. Specifically, the material of the substrate layer may be a polypropylene porous film, a polyethylene porous film, a polypropylene non-woven fabric, a polyethylene non-woven fabric, or a polypropylene-polyethylene-polypropylene porous composite film.

### Electrolyte Solution

According to some embodiments of this application, the electrolyte solution includes an organic solvent, a lithium salt, and optionally an additive.

The organic solvent in the electrolyte solution of this application may be any organic solvent known in the prior art suitable for use as a solvent of the electrolyte solution. An electrolyte used in the electrolyte solution according to this application is not limited and may be any electrolyte known in the prior art. The additive of the electrolyte solution according to this application may be any additive known in the prior art suitable for use as an additive of the electrolyte solution. In some embodiments, the organic solvent includes, but is not limited to: ethylene carbonate (EC), propylene carbonate (PC), diethyl carbonate (DEC), ethyl methyl carbonate (EMC), dimethyl carbonate (DMC), or ethyl propionate.

In some embodiments, the organic solvent includes an ether solvent, such as at least one of 1,3-dioxane (DOL) or ethylene glycol dimethyl ether (DME). In some embodiments, the lithium salt includes at least one of an organic lithium salt or an inorganic lithium salt. In some embodiments, the lithium salt includes, but is not limited to: lithium hexafluorophosphate (LiPF₆), lithium tetrafluoroborate (LiBF₄), lithium difluorophosphate (LiPO₂F₂), lithium bistrifluoromethanesulfonimide LiN(CF3SO₂)₂(LiTFSI), lithium bis(fluorosulfonyl)imide Li(N(SO₂F)₂) (LiFSI), lithium bis(oxalate) borate LiB(C₂O₄)₂ (LiBOB), or lithium difluoro(oxalate)borate LiBF₂(C₂O₄) (LiDFOB). In some embodiments, the additive includes at least one of fluoroethylene carbonate or adiponitrile.

According to some embodiments of this application, the electrochemical apparatus in this application includes, but is not limited to: a lithium-ion battery.

According to this application, the electrochemical apparatus is further used in an electronic apparatus. The electrochemical apparatus supplies power to a load of the electronic apparatus. In the above electronic apparatus, the electrochemical apparatus has good kinetic performance and cycle performance, thereby being conducive to improving the service life and charging efficiency of the electronic apparatus.

The electronic apparatus may include, but is not limited to, a notebook computer, a pen-input computer, a mobile computer, an electronic book player, a portable phone, a portable fax machine, a portable copier, a portable printer, a stereo headset, a video recorder, a liquid crystal television, a hand-held cleaner, a portable CD machine, a mini disc, a transceiver, an electronic organizer, a calculator, a memory card, a portable audio recorder, a radio, a backup power supply, a motor, an automobile, a motorcycle, a power bicycle, a bicycle, a lighting appliance, a toy, a game machine, a clock, a power tool, a flash light, a camera, a large household storage battery, a lithium-ion capacitor, and the like.

The following further describes this application with reference to specific embodiments and comparative embodiments. A person skilled in the art should understand that a preparation method described in this application is only an embodiment, and any other suitable preparation methods are within the scope of this application.

### Embodiment 1

### Preparing a Battery Separator:

Providing a substrate, where a surface of a substrate layer is coated with an inorganic ceramic coating including boehmite and an acrylic acid binder, and based on a mass of the inorganic ceramic coating, a mass percent of the boehmite is 90%.

Adding 90 g of polymer particles (a weight-average molecular weight being 600,000, and polymer monomers including in percent by mass: 5% of methyl acrylate, 78% of styrene, 2% of butadiene and 15% of isobutyl acrylate) into a stirrer, then adding 10 g of sodium carboxymethyl cellulose, stirring the mixture well, adding 5 g of dimethylsiloxane as a wetting agent, then adding deionized water for stirring, and adjusting the viscosity of a slurry to be 2000 μmPa s to 5000 μmPa s and a solid content to be 5% to obtain a bonding layer slurry.

Subsequently, using a silk-screen printing coating method to uniformly coat surfaces of the inorganic ceramic coating and the substrate layer with the above bonding layer slurry, with a coating weight of 1 mg/5000 mm², and subsequently, completing drying in an oven to form a bonding layer, thereby obtaining a separator, where the separator has a porosity of 42.5%, the bonding layer has a thickness of 0.5 μm, and a thickness ratio of the inorganic coating to the substrate layer is 0.4.

### Preparing a Negative Electrode Plate:

Mixing artificial graphite as a negative active material, acetylene black, styrene-butadiene rubber and sodium carboxymethyl cellulose at a mass ratio of 96:1:1.5:1.5, then adding deionized water as a solvent to formulate a negative electrode slurry in which the solid content is 70%, and subsequently, stirring well with a vacuum mixer. Uniformly coating a surface of 8-μm thick copper foil with the negative electrode slurry, drying the same at 110° C., and performing cold-calendering to obtain a negative electrode plate with one side coated with a 150-μm negative active material layer. Performing the above coating steps again on the other side of the negative electrode plate to obtain a negative electrode plate with both sides coated with negative active material layers. Cutting the negative electrode plate into a size of 74 mm×867 mm and welding a tab to the negative electrode plate for use.

### <Preparing a Positive Electrode Plate>

Mixing lithium cobalt oxide as a positive active material, acetylene black and polyvinylidene difluoride (PVDF) at a mass ratio of 94:3:3, then adding N-methyl-pyrrolidone (NMP) as a solvent to formulate a positive electrode slurry in which the solid content is 75%, and subsequently, stirring well with a vacuum mixer. Uniformly coating a surface of 12-μm aluminum foil with the positive electrode slurry, drying the same at 90° C., and performing cold-calendering to obtain a positive electrode plate with one side coated with a 100-μm thick positive active material layer. Performing the above coating steps again on the other side of the positive electrode plate to obtain a positive electrode plate with both sides coated with negative active material layers. Cutting the positive electrode plate into a size of 74 mm×867 mm, and welding a tab onto the positive electrode plate for use.

### <Preparing an Electrolyte Solution>

Mixing ethylene carbonate (EC), diethyl carbonate (DEC), propylene carbonate (PC), propyl propionate (PP) and vinylene carbonate (VC) as a nonaqueous organic solvent at a mass ratio of 20:30:20:28:2 in an environment in which the moisture content is less than 10 ppm, and then adding lithium hexafluorophosphate (LiPF₆) into the nonaqueous organic solvent for dissolving and stirring well to obtain an electrolyte solution. Based on a total mass of the electrolyte solution, a mass content of LiPF₆ is 8%.

### <Preparing a Secondary Battery>

Stacking the above-prepared positive electrode plate, battery separator and negative electrode plate in sequence in such a way that the separator is located between the positive electrode plate and the negative electrode plate to serve a function of separation, where the surface of the separator containing the inorganic ceramic coating directly faces the positive electrode plate and comes into contact with the positive electrode plate, and winding the stacked structure to obtain an electrode assembly. Putting the electrode assembly into an aluminum-plastic film packaging bag, dehydrating the electrode assembly at 80° C., and then injecting the prepared electrolyte solution. Performing steps such as vacuum sealing, standing, chemical formation, and shaping to obtain a secondary battery.

### Test Method of Related Performance of Separator:

### (1) Number Value C and Value D of Polymer Particles

In a scanning electron microscope of a cross section of the separator, at a magnification of 2K, by statistically analyzing a particle size of polymer particles within an area of 11.6 μm×7.6 μm with an image statistics method, and based on a particle size of a single particle, excluding secondary particles formed by a plurality of particles, and recording a number value C and value D of the polymer particles.

### (2) Average Diameter L of Polymer Particles

In a scanning electron microscope of the separator, by statistically analyzing a particle size of polymer particles within an area of 11.6 μm×7.6 μm with an image statistics method, and based on a particle size of a single particle, excluding secondary particles formed by a plurality of particles, recording diameters of the polymer particles, arbitrarily taking diameters of 32 polymer particles, and calculating an average value L thereof.

### (3) Particle Sizes Dv50 and Dv90 of Inorganic Particles

Performing measurement by using a laser particle size analyzer Malvern 3000, adding 50 ml of water into a beaker, adding about 2 g of a material (inorganic particles), and stirring a solution to fully disperse the material. After completing cleaning of a device, adding more than two-thirds of DI water, debugging a rotating speed to 2800±50. Clicking “Initialize Instrument” and waiting for the instrument to complete initialization, clicking “Measure Background”, which requires a laser intensity to be higher than 70% and a background light intensity to be lower than 100. After completing a background test, adding a test sample, when a laser shade degree reaches a specified range of 10-12%, waiting for 5-8 S, clicking “Test Sample”, after completing the test, automatically generating a numerical value, and recording three sets of test data Dv10, Dv50, and Dv90. Setting device parameters: the refractive index is 1.765, the absorptivity is 0.1, and the density is 1.05.

### (4) Thicknesses of Bonding Layer, Inorganic Coating and Separator

Performing testing with a VL 50 ten-thousandth micrometer, specifically, pressing a “▾” button to make a measuring head fit closely with a test platform, and pressing a “zero” button to reset a thickness gauge to zero. Pressing a “▴” button to raise the measuring head, and picking up the separator to lay the same flat on the test platform, such that the separator at a measuring position remains flat on the test platform and the measuring position is aligned with the measuring head. Pressing the “▾” button until the measuring head is stationary. When data remains stable and constant, recording the data in a table; Transversely and uniformly measuring 16 points at intervals of about 1 point every 20 mm; uniformly measuring 16 points in width, and then calculating an average value of the 32 points measured in the transverse and width directions. Similarly, the bonding layer and the inorganic coating use the same measuring method.

### (5) Coating Weight Per Unit Area of Bonding Layer

Die-cutting samples before and after the substrate layer is coated with the bonding layer into long pieces of 50*100 mm in size, measuring weights by using an electronic balance with an accuracy of 4 decimal places, and recording the weights as m1 and m2. Taking 6 measuring points before and after coating to calculate an average value, and calculating to obtain a coating weight per unit area.

### (6) Porosity of Separator

Cutting separator samples into discs with a diameter of 10 mm, and putting the die-cut separator samples into a sample cup. Putting the sample cup into a sample compartment, closing the sample compartment, and performing testing by using a true density meter gas exchange method. Recording a test result, testing each separator sample for three times, and calculating an average value.

### (7) Number of Polymer Particles and Protrusions

In a scanning electron microscope of the separator, by statistically analyzing a particle size of polymer particles within an area of 11.6 μm×7.6 μm with an image statistics method, and based on a particle size of a single particle, excluding secondary particles formed by a plurality of particles, and recording the number of the polymer particles. At a magnification of 10000 of the SEM, selecting a single particle to count the number of protrusions on the particle, then counting the number of protrusions of 32 polymer particles, and calculating an average value thereof.

### Performance Test of Lithium-Ion Battery

### Testing Bonding Force Between Separator and Electrode Plate:

Testing a bonding force between the separator and the positive electrode plate or the negative electrode plate by using the national standard GB/T 2790-1995, i.e., using the 180-degree peel test standard, cutting the separator and the positive electrode plate or the negative electrode plate into samples of 54.2 mm×72.5 mm in size, compositing the separator and the positive electrode plate or the negative electrode plate, hot-pressing the composited structure by using a hot press with hot-pressing conditions of temperature of 85° C., pressure of 1 MPa and hot-pressing time of 85 s (seconds), cutting a composited sample into small pieces of 15 mm×54.2 mm in size, and testing the bonding force between the separator and the positive electrode plate or the negative electrode plate according to the 180-degree peel test standard.

### Testing Low-Temperature Capacity Retention Rate:

At 25° C., charging the lithium-ion battery at a constant current of 0.5 C until the voltage reaches 4.53 V, charging the lithium-ion battery at a constant voltage until the current reaches 0.02 C, then discharging the lithium-ion battery at a constant current of 0.2 C until the voltage reaches 2.5 V, and recording a discharge capacity of the lithium-ion battery at 25° C. at this time. Then charging the lithium-ion battery at a constant current of 0.5 C until the voltage reaches 4.53 V, charging the lithium-ion battery at a constant voltage until the current reaches 0.02 C, then putting the lithium-ion battery at a temperature of −20° C., charging the lithium-ion battery at a constant current of 0.2 C until the voltage reaches 2.5 V, and recording a discharge capacity of the lithium-ion battery at −20° C. at this time. Calculating a capacity retention rate of the lithium-ion battery at −20° C., low-temperature capacity retention rate=(final discharge capacity of secondary battery at −20° C./first-cycle discharge capacity of secondary battery at 25° C.)×100%.

### Testing High-Temperature (45° C.) Cycle Performance:

At 45° C., charging the lithium-ion battery at a constant current of 3 C until the voltage reaches 4.35 V, charging the lithium-ion battery at a constant voltage until the current reaches 1.8 C, and then discharging the lithium-ion battery at 0.7 C until the voltage reaches 3.0 V to complete one cycle, which is denoted as a first cycle. Then repeating the above steps for 800 cycles, and calculating a 800th-cycle capacity retention rate. 800th-cycle capacity retention rate=(800th-cycle discharge capacity/first-cycle discharge capacity)×100%.

### Testing Rate Performance:

At 25° C., charging the lithium-ion battery at a constant current of 0.5 C until the voltage reaches 4.47 V, charging the lithium-ion battery at a constant voltage until the current reaches 0.05 C, and sleeping for 5 min. Then discharging the lithium-ion battery at 0.2 C until the voltage reaches 3.0 V, and sleeping for 5 min. Then charging the lithium-ion battery at a constant current of 0.5 C until the voltage reaches 4.47 V, charging the lithium-ion battery at a constant voltage until the current reaches 0.05 C, and sleeping for 5 min. Then discharging the lithium-ion battery at 0.5 C until the voltage reaches 3.0 V, recording a capacity as D1, and sleeping for 5 min. Then discharging the lithium-ion battery at 2 C until the voltage reaches 3.0 V, and recording a capacity as D2. Rate performance=D2/D1*100%.

### Testing Energy Density:

Charging the lithium-ion battery at a constant current of 0.5 C until the voltage reaches 4.47 V, charging the lithium-ion battery at a constant voltage until the current reaches 0.05 C, and sleeping for 5 min. Then charging the lithium-ion battery at a constant current of 0.2 C until the voltage reaches 3.0 V, and recording a capacity of the lithium-ion battery as D. Based on a size of the lithium-ion battery, calculating a volume V of the lithium-ion battery, where an energy density of the lithium-ion battery=D/V

### Self-Discharge Rate K Value of Lithium-Ion Battery:

Testing an initial voltage V1 of the lithium-ion battery, and after leaving the lithium-ion battery to stand for 48 h, testing a voltage V2 of the lithium-ion battery, where K value=(V1-V2)/48.

### Embodiment 2 to Embodiment 6

Identical to Embodiment 1 except that by adjusting the coating weight per unit area of the bonding layer and adjusting the number of the polymer particles embedded in the inorganic coating, related parameters in Table 1 are obtained.

### Comparative Embodiment 1 to Comparative Embodiment 3

Identical to Embodiment 1 except that by adjusting the particle sizes Dv50 and Dv90 of the inorganic particles in the inorganic coating, related parameters in Table 1 and Table 2 are obtained.

### Embodiment 7 to Embodiment 13

Identical to Embodiment 1 except that by changing the particle size Dv50 of the inorganic coating and the thickness of the inorganic coating, related parameters in Table 3 and Table 4 are obtained.

### Embodiment 14 to Embodiment 25

Identical to Embodiment 1 except that by adjusting the thickness of the inorganic coating or adjusting the average diameter of the polymer particles and the thickness of the bonding layer, related parameters in Table 5 and Table 6 are obtained.

### Embodiment 26 to Embodiment 32

Identical to Embodiment 1 except that by adjusting the porosity of the separator and the ratio of d1/d2, related parameters in Table 7 and Table 8 are obtained.

### Embodiment 33 to Embodiment 36

Identical to Embodiment 1 except that by adjusting the content relationship of the components of the polymer monomers or adjusting the number of the protrusions, related parameters in Table 9 and Table 10 are obtained.

TABLE 1

| | Inorganic coating | | | Bonding layer | | |
|---|---|---|---|---|---|---|
| | Particle size | Particle size | | | Average | Coating weight |
| | Dv50 of | Dv90 of | | | diameter | per unit |
| | inorganic | inorganic | Thickness | | of polymer | area of |
| | particles | particles | d1 | | particles | bonding layer |
| | (μm) | (μm) | (μm) | Polymer monomer | (μm) | (mg/5000 mm²) |
| Embodiment 1 | 0.86 | 1.35 | 1.2 | 5% of methyl acrylate, | 0.65 | 1 |
| | | | | 78% of styrene, | | |
| | | | | 2% of butadiene, and | | |
| | | | | 15% of isobutyl acrylate | | |
| Embodiment 2 | 0.86 | 1.35 | 1.2 | 5% of methyl acrylate, | 0.65 | 0.87 |
| | | | | 78% of styrene, | | |
| | | | | 2% of butadiene, and | | |
| | | | | 15% of isobutyl acrylate | | |
| Embodiment 3 | 0.86 | 1.35 | 1.2 | 5% of methyl acrylate, | 0.65 | 0.8 |
| | | | | 78% of styrene, | | |
| | | | | 2% of butadiene, and | | |
| | | | | 15% of isobutyl acrylate | | |
| Embodiment 4 | 0.86 | 1.35 | 1.2 | 5% of methyl acrylate, | 0.65 | 0.7 |
| | | | | 78% of styrene, | | |
| | | | | 2% of butadiene, and | | |
| | | | | 15% of isobutyl acrylate | | |
| Embodiment 5 | 0.86 | 1.35 | 1.2 | 5% of methyl acrylate, | 0.65 | 0.6 |
| | | | | 78% of styrene, | | |
| | | | | 2% of butadiene, and | | |
| | | | | 15% of isobutyl acrylate | | |
| Embodiment 6 | 0.86 | 1.35 | 1.2 | 5% of methyl acrylate, | 0.65 | 1 |
| | | | | 78% of styrene, | | |
| | | | | 2% of butadiene, and | | |
| | | | | 15% of isobutyl acrylate | | |
| Comparative | 0.55 | 0.8 | 1.2 | 5% of methyl acrylate, | 0.65 | 1 |
| Embodiment 1 | | | | 78% of styrene, | | |
| | | | | 2% of butadiene, and | | |
| | | | | 15% of isobutyl acrylate | | |
| Comparative | 0.45 | 0.55 | 1.2 | 5% of methyl acrylate, | 0.65 | 1 |
| Embodiment 2 | | | | 78% of styrene, | | |
| | | | | 2% of butadiene, and | | |
| | | | | 15% of isobutyl acrylate | | |
| Comparative | 1.09 | 1.91 | 1.2 | Polyvinylidene fluoride | 6.5 | 1 |
| Embodiment 3 | | | | | | |

TABLE 2

| | Number of | | Ratio of | | | | | |
|---|---|---|---|---|---|---|---|---|
| | embedded | | number of | | | | Capacity | |
| | polymer | Total | embedded | K value of | 800th-cycle | | retention | |
| | particles | number of | polymer | lithium-ion | retention | Energy | rate | Rate |
| | (C = 7.6d1 + | polymer | particles | battery | rate at | density | at −20° | performance |
| | 7.4) | particles | C/D | mV/h | 45° C. | (Wh/L) | C. (%) | (%) |
| Embodiment 1 | 7.4) | 30 | 0.57 | 0.026 | 91.5 | 785 | 82.6 | 86.5 |
| Embodiment 2 | 17.0 | 26 | 0.65 | 0.026 | 91.8 | 786 | 82.5 | 86.8 |
| Embodiment 3 | 17.0 | 24 | 0.71 | 0.026 | 92 | 787 | 82.7 | 87.0 |
| Embodiment 4 | 17.0 | 21 | 0.80 | 0.026 | 92 | 788 | 82.8 | 87.3 |
| Embodiment 5 | 17.0 | 18 | 0.94 | 0.026 | 91.3 | 789 | 82.7 | 87.5 |
| Embodiment 6 | 17.0 | 34 | 0.50 | 0.028 | 91.3 | 786 | 82.5 | 85.6 |
| Comparative | 14.0 | 30 | 0.37 | 0.03 | 79.2 | 755 | 76.5 | 78.9 |
| Embodiment 1 | | | | | | | | |
| Comparative | 12.0 | 30 | 0.45 | 0.031 | 79.6 | 756 | 76.8 | 78.4 |
| Embodiment 2 | | | | | | | | |
| Comparative | 0.0 | 5 | 0.00 | 0.033 | 78.5 | 751 | 77.9 | 77.4 |
| Embodiment 3 | | | | | | | | |

As can be seen from the above Table 1 and Table 2, when the ratio of the number of embedded polymer particles C/D is greater than or equal to 0.5, it can increase the K value, energy density, rate performance, low-temperature performance and high-temperature cycle performance of the lithium-ion battery.

TABLE 3

| | | | | Ratio of |
|---|---|---|---|---|
| | | | | average |
| | | | | diameter |
| | Particle size | Particle size | Thickness | L of polymer |
| | Dv50 of | Dv90 of | d1 of | particles to |
| | inorganic | inorganic | inorganic | Dv50 of |
| | particles | particles | coating | inorganic |
| | (μm) | (μm) | (μm) | particles |
| Embodiment 7 | 0.85 | 1.56 | 1.5 | 0.76 |
| Embodiment 8 | 1.09 | 1.91 | 2 | 0.60 |
| Embodiment 9 | 1.23 | 2.23 | 2.2 | 0.53 |
| Embodiment 10 | 1.64 | 2.73 | 2.9 | 0.40 |
| Embodiment 11 | 0.98 | 1.35 | 1.4 | 0.66 |
| Embodiment 12 | 0.73 | 1.65 | 1.2 | 0.90 |
| Embodiment 13 | 1.74 | 2.86 | 3.0 | 0.30 |

TABLE 4

| | | | Bonding | Bonding | | | | | |
|---|---|---|---|---|---|---|---|---|---|
| | Number of | Ratio of | force | force | | | | | |
| | embedded | number of | between | between | K value of | | | Capacity | |
| | polymer | embedded | separator | separator | lithium- | 800th-cycle | | retention | |
| | particles | polymer | and positive | and negative | ion | retention | Energy | rate | Rate |
| | (C = 7.6d1 + | particles | electrode | electrode | battery | rate at | density | at −20° | performance |
| | 7.4) | C/D | plate (N/m) | plate (N/m) | mV/h | 45° C. | (Wh/L) | C. (%) | (%) |
| Embodiment 7 | 19.0 | 0.63 | 9.4 | 13.8 | 0.024 | 92.5 | 783 | 83.1 | 86.8 |
| Embodiment 8 | 23.0 | 0.77 | 7.4 | 14.2 | 0.022 | 93.2 | 780 | 83.6 | 87.1 |
| Embodiment 9 | 24.0 | 0.80 | 4.5 | 14.2 | 0.021 | 89.2 | 778 | 84.2 | 86.9 |
| Embodiment 10 | 29.0 | 0.97 | 4.0 | 14.2 | 0.020 | 88.6 | 774 | 83.2 | 86.5 |
| Embodiment 11 | 18.0 | 0.60 | 10.2 | 14.2 | 0.024 | 91.9 | 784 | 83.6 | 86.8 |
| Embodiment 12 | 17.0 | 0.57 | 11.0 | 14.2 | 0.021 | 85.4 | 772 | 81.1 | 84.1 |
| Embodiment 13 | 30.0 | 1.00 | 3.6 | 14.2 | 0.021 | 86.1 | 771 | 82.1 | 85.1 |

TABLE 5

| | Inorganic coating | | | | | Ratio of average |
|---|---|---|---|---|---|---|
| | Particle size | Particle size | | Bonding layer | | diameter L of |
| | Dv50 of | Dv90 of | | Average | | polymer particles |
| | inorganic | inorganic | Thickness | diameter of | Thickness | to Dv50 of |
| | particles | particles | d1 | polymer | of bonding | inorganic |
| | (μm) | (μm) | (μm) | particles (μm) | layer (μm) | particles |
| Embodiment 14 | 0.45 | 0.78 | 0.5 | 0.35 | 0.5 | 0.78 |
| Embodiment 15 | 0.85 | 1.35 | 1.5 | 0.65 | 0.5 | 0.76 |
| Embodiment 16 | 0.85 | 1.35 | 2 | 0.65 | 0.5 | 0.76 |
| Embodiment 17 | 0.85 | 1.35 | 2.5 | 0.65 | 0.5 | 0.76 |
| Embodiment 18 | 0.85 | 1.35 | 3 | 0.65 | 0.5 | 0.76 |
| Embodiment 19 | 1.23 | 2.23 | 5 | 0.65 | 0.5 | 0.53 |
| Embodiment 20 | 0.45 | 0.78 | 1 | 0.3 | 0.3 | 0.67 |
| Embodiment 21 | 0.56 | 0.78 | 1.4 | 0.4 | 0.4 | 0.71 |
| Embodiment 22 | 1.23 | 2.23 | 1.2 | 0.8 | 0.8 | 0.65 |
| Embodiment 23 | 1.32 | 2.23 | 1.3 | 1.0 | 0.9 | 0.76 |
| Embodiment 24 | 6.5 | 8.7 | 6.5 | 5.0 | 5.1 | 0.77 |
| Embodiment 25 | 0.4 | 0.45 | 0.34 | 0.65 | 0.5 | 1.63 |

TABLE 6

| | Number of | Ratio of | Bonding force | Bonding force | | | | | |
|---|---|---|---|---|---|---|---|---|---|
| | embedded | number of | between | between | | | | Capacity | |
| | polymer | embedded | separator | separator | K value of | 800th-cycle | | retention | |
| | particles | polymer | and positive | and negative | lithium-ion | retention | Energy | rate | Rate |
| | (C = 7.6d1 + | particles | electrode | electrode | battery | rate at | density | at −20° | performance |
| | 7.4) | C/D | plate (N/m) | plate (N/m) | mV/h | 45° C. | (Wh/L) | C. (%) | (%) |
| Embodiment 14 | 11.0 | 0.55 | 11.2 | 16.3 | 0.032 | 91.5 | 790 | 82.8 | 85.9 |
| Embodiment 15 | 19.0 | 0.63 | 10.5 | 14.2 | 0.024 | 91.5 | 783 | 82.6 | 86.2 |
| Embodiment 16 | 23 | 0.77 | 10.5 | 14.2 | 0.021 | 91.2 | 780 | 82.4 | 86.1 |
| Embodiment 17 | 26 | 0.87 | 10.5 | 14.2 | 0.02 | 90.8 | 777 | 82.1 | 85.8 |
| Embodiment 18 | 30 | 0.94 | 10.5 | 14.2 | 0.019 | 90.5 | 773 | 81.8 | 85.4 |
| Embodiment 19 | 45 | 0.94 | 10.5 | 14.2 | 0.018 | 87.8 | 761 | 81.1 | 84.6 |
| Embodiment 20 | 11 | 0.55 | 12.8 | 16.5 | 0.032 | 91.9 | 791 | 81.5 | 85.8 |
| Embodiment 21 | 17 | 0.57 | 12.5 | 15.8 | 0.026 | 91.1 | 787 | 82.4 | 85.2 |
| Embodiment 22 | 17 | 0.94 | 9.8 | 12.5 | 0.025 | 91.8 | 784 | 83.1 | 85.7 |
| Embodiment 23 | 17 | 0.85 | 8.5 | 11.1 | 0.025 | 92.1 | 782 | 83.5 | 86.1 |
| Embodiment 24 | 56 | 0.80 | 4.6 | 6.5 | 0.02 | 85.4 | 760 | 80.9 | 83.5 |
| Embodiment 25 | 10 | 0.91 | 0.5 | 13.8 | 0.036 | 91.5 | 792 | 80.2 | 84.4 |

As can be seen from the above Table 5 and Table 6, in Embodiment 14 to Embodiment 19 and Embodiment 24 to Embodiment 25, the thickness of the inorganic coating is changed, and when the thickness of the inorganic coating is within an appropriate range, the lithium-ion battery prepared therefrom has a good K value, low-temperature performance and rate performance.

In Embodiment 20 to Embodiment 24, the average diameter of the polymer particles and the thickness of the bonding layer are adjusted within an appropriate range. The lithium-ion battery assembled and prepared therefrom has good high-temperature cycle performance, low-temperature performance and rate performance.

TABLE 7

| | | | | Ratio of | |
|---|---|---|---|---|---|
| | Particle | Particle | | average | |
| | size | size | Thickness | diameter of | |
| | Dv50 | Dv90 | d1 of | polymer particles | Porosity |
| | of inorganic | of inorganic | inorganic | to Dv50 of | of |
| | particles | particles | coating | inorganic | separator |
| | (μm) | (μm) | (μm) | particles | (%) |
| Embodiment 26 | 0.74 | 1.35 | 1.2 | 0.81 | 30.20 |
| Embodiment 27 | 0.74 | 1.35 | 1.2 | 0.81 | 50.10 |
| Embodiment 28 | 0.74 | 1.35 | 1.2 | 0.81 | 42.50 |
| Embodiment 29 | 0.74 | 1.35 | 1.2 | 0.81 | 42.50 |
| Embodiment 30 | 0.74 | 1.35 | 1.2 | 0.81 | 42.50 |
| Embodiment 31 | 0.74 | 1.35 | 1.2 | 0.81 | 42.50 |
| Embodiment 32 | 0.74 | 1.35 | 1.2 | 0.81 | 42.50 |

TABLE 8

| | | Ratio of | | | | | |
|---|---|---|---|---|---|---|---|
| | Thickness d1 | number of | | | | Capacity | |
| | of inorganic | embedded | K value of | 800th-cycle | | retention | |
| | coating/thickness | polymer | lithium-ion | retention | Energy | rate | Rate |
| | d2 of substrate | particles | battery | rate at | density | at −20° | performance |
| | layer | C/D | mV/h | 45° C. | (Wh/L) | C. (%) | (%) |
| Embodiment 26 | 0.40 | 0.57 | 0.022 | 88.6 | 785 | 81.4 | 83.4 |
| Embodiment 27 | 0.40 | 0.57 | 0.028 | 93.2 | 785 | 83.7 | 86.7 |
| Embodiment 28 | 0.40 | 0.57 | 0.026 | 91.7 | 787 | 82.7 | 84.5 |
| Embodiment 29 | 0.29 | 0.57 | 0.026 | 91.1 | 781 | 82.2 | 84.6 |
| Embodiment 30 | 0.60 | 0.57 | 0.026 | 91.2 | 783 | 82.4 | 83.2 |
| Embodiment 31 | 0.05 | 0.57 | 0.038 | 91.5 | 783 | 82.8 | 83.3 |
| Embodiment 32 | 1.00 | 0.57 | 0.015 | 91.8 | 783 | 82.6 | 83.5 |

In Table 7 and Table 8, in Embodiment 26 to Embodiment 28, the porosity of the separator is changed, and when the porosity of the separator is within an appropriate range, the lithium-ion battery assembled therefrom has good high-temperature cycle performance, low-temperature performance and rate performance.

In Embodiment 28 to Embodiment 32, the ratio of the thickness d1 of the inorganic coating to the thickness d2 of the substrate layer is changed within an appropriate range. The lithium-ion battery has a good energy density, high-temperature cycle performance and rate performance.

TABLE 9

| | | | Bonding | Bonding | | | | | |
|---|---|---|---|---|---|---|---|---|---|
| | | Ratio of | force | force | | | | | |
| | | number of | between | between | K value of | | | Capacity | |
| | | embedded | separator | separator | lithium- | 800th-cycle | | retention | |
| | | polymer | and positive | and negative | ion | retention | Energy | rate | Rate |
| | | particles | electrode | electrode | battery | rate at | density | at −20° | performance |
| | Polymer monomer | C/D | plate (N/m) | plate (N/m) | mV/h | 45° C. | (Wh/L) | C. (%) | (%) |
| Embodiment 28 | 5% of methyl acrylate, | 0.57 | 10.5 | 14.2 | 0.026 | 91.7 | 787 | 82.7 | 84.5 |
| | 78% of styrene, 2% of | | | | | | | | |
| | butadiene, and 15% of | | | | | | | | |
| | isobutyl acrylate | | | | | | | | |
| Embodiment 33 | 78% of styrene, 2% of | 0.68 | 11.1 | 14.2 | 0.015 | 91.8 | 783 | 82.6 | 83.5 |
| | acrylic acid, and 20% | | | | | | | | |
| | of isobutyl acrylate | | | | | | | | |
| Embodiment 34 | 83% of styrene, 2% of | 0.68 | 10.9 | 14.2 | 0.015 | 91.8 | 783 | 82.6 | 83.5 |
| | acrylic acid, and 15% | | | | | | | | |
| | of isobutyl acrylate | | | | | | | | |

In Table 9, in Embodiment 28 and Embodiments 33 to 34, among different polymer monomers, the obtained polymer particles are used in the separator, there is a good bonding force between the separator and the positive/negative electrode plate, and the lithium-ion battery assembled and prepared therefrom has a good energy density, high-temperature cycle performance and rate performance.

TABLE 10

| | | | Bonding | Bonding | | | | | |
|---|---|---|---|---|---|---|---|---|---|
| | | | force | force | | | | | |
| | | | between | between | K value of | | | Capacity | |
| | | | separator | separator | lithium- | 800th-cycle | | retention | |
| | | | and positive | and negative | ion | retention | Energy | rate | Rate |
| | | Number of | electrode | electrode | battery | rate at | density | at −20° | performance |
| | Polymer monomer | protrusions | plate (N/m) | plate (N/m) | mV/h | 45° C. | (Wh/L) | C. (%) | (%) |
| Embodiment 1 | 5% of methyl acrylate, | 20 | 10.5 | 14.2 | 0.026 | 91.5 | 785 | 82.6 | 86.5 |
| | 78% of styrene, | | | | | | | | |
| | 2% of butadiene, and | | | | | | | | |
| | 15% of isobutyl acrylate | | | | | | | | |
| Embodiment 35 | 1% of methyl acrylate, | 5 | 7.5 | 11.5 | 0.026 | 91.2 | 784 | 82.5 | 86.4 |
| | 82% of styrene, | | | | | | | | |
| | 2% of butadiene, and | | | | | | | | |
| | 15% of isobutyl acrylate | | | | | | | | |
| Embodiment 36 | 15% of methyl acrylate, | 50 | 12.6 | 16.2 | 0.026 | 92 | 785 | 82.7 | 86.8 |
| | 68% of styrene, | | | | | | | | |
| | 2% of butadiene, and | | | | | | | | |
| | 15% of isobutyl acrylate | | | | | | | | |

As can be seen from the above Table 10, by changing the mass percent of the menthyl acrylate in the polymer monomers, the number of the protrusions on the surface of each polymer particle can be changed, and the number of the protrusions is within an appropriate range, which is conductive to allowing a good bonding force between the separator and the positive electrode plate/negative electrode plate, and improving the high-temperature cycle performance of the lithium-ion battery.

The above disclosure is only a better embodiment of this application, of course, can not be used to limit this application, so the equivalent changes made in accordance with this application are still covered by the scope of this application.

What is claimed is:

1. A separator, comprising a substrate layer, an inorganic coating, and a bonding layer; wherein the inorganic coating is disposed between the substrate layer and the bonding layer, the inorganic coating comprises inorganic particles, the bonding layer comprises polymer particles, and at least part of the polymer particles are embedded in pores of the inorganic coating; and in a scanning electron microscope image of a cross section of the separator at a magnification of 2000, within an area of 11.6 μm×7.6 μm, a number of polymer particles embedded in the inorganic coating at a depth greater than or equal to 100 nm is C, and a total number of polymer particles in the cross section is D, wherein 0.5≤C/D<0.94.

2. The separator according to claim 1, wherein 0.71≤C/D<0.94.

3. The separator according to claim 1, wherein an average diameter L of the polymer particles and a particle size Dv50 of the inorganic particles satisfy: 0.4≤L/Dv50≤0.8.

4. The separator according to claim 1, wherein the separator satisfies at least one of the following conditions:
(1) the inorganic coating has a thickness of 0.5 μm to 5 μm;
(2) the inorganic coating has a thickness of d1 μm, and C=7.6d1+7.4;
(3) the polymer particles have an average diameter L of 0.3 μm to 5 μm;
(4) the inorganic particles have particle sizes Dv50 in a range of 0.4 μm to 6.5 μm and Dv90 in a range of 0.8 μm to 8.7 μm;
(5) the bonding layer has a thickness of 0.5 μm to 2 μm and has a coating weight per unit area of 0.5 mg/5000 mm² to 3 mg/5000 mm²; or
(6) the inorganic coating has a thickness of d1, the substrate layer has a thickness of d2, and 0.05≤d1/d2≤1.0.

5. The separator according to claim 1, wherein the inorganic particles comprise at least one of aluminum oxide, silicon dioxide, magnesium oxide, titanium oxide, hafnium dioxide, tin oxide, cerium dioxide, nickel oxide, zirconium oxide, zinc oxide, calcium oxide, boehmite, aluminum hydroxide, magnesium hydroxide, calcium hydroxide or barium sulfate;
the inorganic coating further comprises a binder; and the binder comprises at least one of acrylic acid, methyl methacrylate, butyl acrylate, octyl acrylate, isooctyl acrylate, butadiene or acrylonitrile; and
based on a mass of the inorganic coating, a mass percentage of the inorganic particles is 85% to 95%.

6. The separator according to claim 1, wherein the polymer particles in the bonding layer are formed by polymerization of at least two monomers selected from: butadiene, methyl acrylate, methyl methacrylate, styrene, butyl methacrylate, isooctyl acrylate, isobutyl acrylate, ethylene, propylene or vinylidene fluoride; and
the polymer particles further comprise at least one of acrylic acid, acrylonitrile or butadiene.

7. The separator according to claim 1, wherein the separator has a porosity of 30% to 50%.

8. The separator according to claim 1, wherein a surface of each polymer particle has a plurality of protrusions; and in a scanning electron microscope image of the separator at a magnification of 10000, within an area of 11.6 μm×7.6 μm, a number of the protrusions in each polymer particle is 5 to 50.

9. The separator according to claim 1, wherein the separator comprises two bonding layers, one of the bonding layers is located on a surface of the inorganic coating facing away from the substrate layer, and the other one of the bonding layers being located on a surface of the substrate layer facing away from the inorganic coating.

10. An electrochemical apparatus, comprising an electrode assembly, the electrode assembly comprising a positive electrode plate and a negative electrode plate; wherein the electrode assembly further comprises a separator, the separator is located between the positive electrode plate and the negative electrode plate;
wherein the separator comprises a substrate layer, an inorganic coating and a bonding layer; wherein the inorganic coating is disposed between the substrate layer and the bonding layer, the inorganic coating comprises inorganic particles, the bonding layer comprises polymer particles, and at least part of the polymer particles are embedded in pores of the inorganic coating; and in a scanning electron microscope image of a cross section of the separator at a magnification of 2000, within an area of 11.6 μm×7.6 μm, a number of polymer particles embedded in the inorganic coating at a depth greater than or equal to 100 nm is C, and a total number of polymer particles in the cross section is D, wherein 0.5≤C/D<0.94.

11. The electrochemical apparatus according to claim 10, wherein 0.71≤C/D<0.94.

12. The electrochemical apparatus according to claim 10, wherein an average diameter L of the polymer particles and a particle size Dv50 of the inorganic particles satisfy: 0.4≤L/Dv50≤0.8.

13. The electrochemical apparatus according to claim 10, wherein the separator satisfies at least one of the following conditions:
(1) the inorganic coating has a thickness of 0.5 μm to 5 μm;
(2) the inorganic coating has a thickness of d1 μm, and C=7.6d1+7.4;
(3) the polymer particles have an average diameter L of 0.3 μm to 5 μm;
(4) the inorganic particles have particle sizes Dv50 in a range of 0.4 μm to 6.5 μm and Dv90 in a range of 0.8 μm to 8.7 μm;
(5) the bonding layer has a thickness of 0.5 μm to 2 μm and has a coating weight per unit area of 0.5 mg/5000 mm² to 3 mg/5000 mm²; or
(6) the inorganic coating has a thickness of d1, the substrate layer has a thickness of d2, and 0.05≤d1/d2≤1.0.

14. The electrochemical apparatus according to claim 10, wherein the inorganic particles comprise at least one of aluminum oxide, silicon dioxide, magnesium oxide, titanium oxide, hafnium dioxide, tin oxide, cerium dioxide, nickel oxide, zirconium oxide, zinc oxide, calcium oxide, boehmite, aluminum hydroxide, magnesium hydroxide, calcium hydroxide or barium sulfate;
the inorganic coating further comprises a binder, and the binder comprises at least one of acrylic acid, methyl methacrylate, butyl acrylate, octyl acrylate, isooctyl acrylate, butadiene or acrylonitrile; and
based on a mass of the inorganic coating, a mass percent of the inorganic particles is 85% to 95%.

15. The electrochemical apparatus according to claim 10, wherein the polymer particles in the bonding layer are formed by polymerization of at least two monomers selected from: butadiene, methyl acrylate, methyl methacrylate, styrene, butyl methacrylate, isooctyl acrylate, isobutyl acrylate, ethylene, propylene or vinylidene fluoride; and
the polymer particles further comprise at least one of acrylic acid, acrylonitrile or butadiene.

16. The electrochemical apparatus according to claim 10, wherein the separator has a porosity of 30% to 50%.

17. The electrochemical apparatus according to claim 10, wherein a surface of each polymer particle has a plurality of protrusions, and in a scanning electron microscope image of the separator at a magnification of 10000, within an area of 11.6 μm×7.6 μm, a number of the protrusions in each polymer particle is 5 to 50.

18. The electrochemical apparatus according to claim 10, wherein the separator comprises two bonding layers, one of the bonding layers is located on a surface of the inorganic coating facing away from the substrate layer, and the other one of the bonding layers being located on a surface of the substrate layer facing away from the inorganic coating.

19. The electrochemical apparatus according to claim 10, wherein D satisfies: 18≤C/D<24.

20. An electronic apparatus, comprising an electrochemical apparatus, wherein the electrochemical apparatus comprises an electrode assembly, the electrode assembly comprises a positive electrode plate and a negative electrode plate; wherein the electrode assembly further comprises a separator, the separator is located between the positive electrode plate and the negative electrode plate;
wherein the separator comprises a substrate layer, an inorganic coating and a bonding layer; wherein the inorganic coating is disposed between the substrate layer and the bonding layer, the inorganic coating comprises inorganic particles, the bonding layer comprises polymer particles, and at least part of the polymer particles are embedded in pores of the inorganic coating; and in a scanning electron microscope image of a cross section of the separator at a magnification of 2000, within an area of 11.6 μm×7.6 μm, a number of polymer particles embedded in the inorganic coating at a depth greater than or equal to 100 nm is C, and a total number of polymer particles in the cross section is D, wherein 0.5≤C/D<0.94.
